(19) United States
(12) Patent Application Publication
(10) Pub. No.: US 2026/0281835 A1
(43) Pub. Date: Sep. 17, 2026

(54) APPARATUS, METHOD, AND COMPUTER PROGRAM FOR REDUCING SETUP DELAY IN DUAL CONNECTIVITY OR CARRIER AGGREGATION

(71) Applicant: NOKIA TECHNOLOGIES OY, Espoo (FI)

(72) Inventors: Lars DALSGAARD, Oulu (FI); Jani-Pekka KAINULAINEN, Cottenham (GB); Riikka Karoliina DIMNIK, Kirkkonummi (FI); Ali KARIMIDEHKORDI, Munich (DE); Niko KOLEHMAINEN, Jorvas (FI)

(21) Appl. No.: 19/167,056

(22) PCT Filed: Mar. 5, 2024
(86) PCT No.: PCT/EP2024/055692

§ 371 Date: Sep. 19, 2025

(30) Foreign Application Priority Data
Mar. 20, 2023 (GB) 2304042.1

(51) Int. Cl. H04W 36/00

(52) U.S. Cl. CPC H04W 36/00692; H04W 36/0085

(57) ABSTRACT

There is provided a method, computer program and apparatus for causing a user equipment to perform: implementing dual connectivity and/or carrier aggregation within a communications network, the means for implementing dual connectivity and/or carrier aggregation within a communications network being able to perform simultaneous measurements for serving and another carrier, the another carrier being a dual connectivity and/or carrier aggregation target carrier; determining, following an idle and/or an inactive mode of operation, initiating a connection; and implementing a measurement behaviour starting from the determining, the measurement behaviour configured to reduce setup delay with respect to the implementing dual connectivity and/or carrier aggregation.

### FIELD OF THE DISCLOSURE

The examples described herein generally relate to apparatus, methods, and computer programs, and more particularly (but not exclusively) to apparatus, methods and computer programs for apparatuses.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

A terminal may be referred to as user equipment (UE) or user device. A terminal is provided with an appropriate signal receiving and transmitting apparatus for enabling wireless communications, for example enabling access to a communication network or communications directly with other terminals. The terminal may access a carrier provided by a base station, for example a base station of a radio access network, and transmit or receive, or transmit and receive communications on the carrier.

A communication system and associated compatible terminals typically operate in accordance with a given standard or specification which sets out what various network entities of the communication system are permitted to do and how that should be achieved. Communication protocols, or parameters, or protocols and parameters which shall be used for communications are also typically defined. One example of a communications system is a Universal Mobile Telecommunications System (UMTS) system (e.g., a communication system using 3G radio access technology). Other examples of communication systems are so called 4G systems (e.g., communication systems operating using 4G radio access technology) and 5G or New Radio (NR) systems (e.g., communication systems operating using 5G or NR radio access technology). Radio access technologies that are used by communication systems are standardized by the 3rd Generation Partnership Project (3GPP).

### SUMMARY

According to an aspect, there is provided a method for an apparatus for a communication network, the method comprising: implementing dual connectivity and/or carrier aggregation within a communications network, implementing dual connectivity and/or carrier aggregation within a communications network being able to perform simultaneous measurements for serving and another carrier, the another carrier being a dual connectivity and/or carrier aggregation target carrier; determining, following an idle and/or an inactive mode of operation, initiating a connection; and implementing a measurement behaviour starting from the determining, the measurement behaviour configured to reduce setup delay with respect to the implementing dual connectivity and/or carrier aggregation.

Implementing a measurement behaviour starting from the determining, the measurement behaviour configured to reduce any setup delay with respect to the implementing dual connectivity and/or carrier aggregation may further comprise: determining the apparatus has no detected cell with respect to a second link of the dual connectivity and/or carrier aggregation; measuring the second carrier based on at least a determined time period for primary synchronization signal or secondary synchronization signal detection.

Implementing dual connectivity and/or carrier aggregation within a communications network being able to perform simultaneous measurements for at least one frequency range may comprise implementing dual connectivity and/or carrier aggregation within a communications network being able to perform simultaneous measurements for at least two frequency ranges, and the second link of the dual connectivity and/or carrier aggregation employs a second frequency range.

The determined time period may be a synchronization without gaps integer multiplied by a synchronization signal block based measurement timing configuration or synchronization signal block period for a measured cell.

The synchronization without gaps integer may be 24.

Implementing a measurement behaviour starting from the determining, the measurement behaviour configured to reduce any setup or resume delay with respect to the implementing dual connectivity and/or carrier aggregation may further comprise: determining the apparatus has one or more detected cell with respect to a second link of the dual connectivity and/or carrier aggregation; measuring over the second link based on a measurement time period.

Implementing a measurement behaviour starting from the determining, the measurement behaviour configured to reduce any setup or resume delay with respect to the implementing dual connectivity and/or carrier aggregation may further comprise: determining the apparatus has valid measurements with respect to a second link of the dual connectivity and/or carrier aggregation; and reporting the valid measurements with no measurement time period delay.

Implementing a measurement behaviour starting from the determining, the measurement behaviour configured to reduce any setup or resume delay with respect to the implementing dual connectivity and/or carrier aggregation may further comprise: determining the apparatus has valid measurements with respect to a second link of the dual connectivity; and measuring over the second link based on a measurement time period.

The determined measurement time period may be a measurement without gaps integer multiplied by a synchronization Signal Block based measurement timing configuration or synchronization signal block period for a measured cell.

The measurement without gaps integer may be a first value when the measured cell is reported and a second value otherwise.

The first value may be: 0 when a cell index is not acquired and there is a first T_{SSB_time_index_emr_inter} value of 10 samples; 3 when a cell index is not acquired and there is a second T_{SSB_time_index_emr_inter} value of 40 samples; and 0 when a cell index is acquired.

The second value may be 24.

Implementing a measurement behaviour starting from the determining, the measurement behaviour configured to reduce any setup or resume delay with respect to the implementing dual connectivity and/or carrier aggregation further may comprise: determining the apparatus has invalid or incomplete measurements with respect to a second link of the dual connectivity; and validating over a validation time period the invalid or incomplete measurements.

Implementing a measurement behaviour starting from the determining, the measurement behaviour configured to reduce any setup or resume delay with respect to the implementing dual connectivity and/or carrier aggregation may further comprise: determining the apparatus has invalid or incomplete measurements with respect to a second link of the dual connectivity; and measuring over the second link based on an index reading time period.

The index reading time period may be an index reading period without gaps integer multiplied by a synchronization Signal Block based measurement timing configuration period or Signal Block based for a measured cell.

The index reading period without gaps integer may be a first value when the measured cell is reported and a second values otherwise.

The first value may be 0.

The second value may be one of: 6; 5; 4; 3; 2; and 1.

Implementing a measurement behaviour starting from the determining, the measurement behaviour configured to reduce any setup or resume delay with respect to the implementing dual connectivity and/or carrier aggregation may further comprise: determining the apparatus has measurements with respect to a second link of the dual connectivity; and further measuring over the second link based on an index reading time period validating over a validation time period a further set of measurements.

The index reading time period may be an index reading period without gaps integer multiplied by a synchronization Signal Block based measurement timing configuration period for a measured cell, the index reading period without gaps integer being a first value.

The first value may be 12. According to a second aspect there is provided an apparatus for a communication network, the apparatus comprising means for: implementing dual connectivity and/or carrier aggregation within a communications network, the means for implementing dual connectivity and/or carrier aggregation within a communications network being able to perform simultaneous measurements for serving and another carrier, the another carrier being a dual connectivity and/or carrier aggregation target carrier; determining, following an idle and/or an inactive mode of operation, initiating a connection; and implementing a measurement behaviour starting from the determining, the measurement behaviour configured to reduce setup delay with respect to the implementing dual connectivity and/or carrier aggregation.

The means for implementing a measurement behaviour starting from the determining, the measurement behaviour configured to reduce any setup delay with respect to the implementing dual connectivity and/or carrier aggregation may further be for: determining the apparatus has no detected cell with respect to a second link of the dual connectivity and/or carrier aggregation; measuring the second carrier based on at least a determined time period for primary synchronization signal or secondary synchronization signal detection.

The means for implementing dual connectivity and/or carrier aggregation within a communications network being able to perform simultaneous measurements for at least one frequency range may be further for implementing dual connectivity and/or carrier aggregation within a communications network being able to perform simultaneous measurements for at least two frequency ranges, and the second link of the dual connectivity and/or carrier aggregation employs a second frequency range.

The determined time period may be a synchronization without gaps integer multiplied by a synchronization signal block based measurement timing configuration or synchronization signal block period for a measured cell.

The synchronization without gaps integer may be 24.

The means for implementing a measurement behaviour starting from the determining, the measurement behaviour configured to reduce any setup or resume delay with respect to the implementing dual connectivity and/or carrier aggregation may further be for: determining the apparatus has one or more detected cell with respect to a second link of the dual connectivity and/or carrier aggregation; measuring over the second link based on a measurement time period.

The means for implementing a measurement behaviour starting from the determining, the measurement behaviour configured to reduce any setup or resume delay with respect to the implementing dual connectivity and/or carrier aggregation may further be for: determining the apparatus has valid measurements with respect to a second link of the dual connectivity and/or carrier aggregation; and reporting the valid measurements with no measurement time period delay.

The means for implementing a measurement behaviour starting from the determining, the measurement behaviour configured to reduce any setup or resume delay with respect to the implementing dual connectivity and/or carrier aggregation may further be for: determining the apparatus has valid measurements with respect to a second link of the dual connectivity; and measuring over the second link based on a measurement time period.

The determined measurement time period may be a measurement without gaps integer multiplied by a synchronization Signal Block based measurement timing configuration or synchronization signal block period for a measured cell.

The measurement without gaps integer may be a first value when the measured cell is reported and a second value otherwise.

The first value may be: 0 when a cell index is not acquired and there is a first T_{SSB_time_index_emr_inter} value of 10 samples; 3 when a cell index is not acquired and there is a second T_{SSB_time_index_emr_inter} value of 40 samples; and 0 when a cell index is acquired.

The second value may be 24.

The means for implementing a measurement behaviour starting from the determining, the measurement behaviour configured to reduce any setup or resume delay with respect to the implementing dual connectivity and/or carrier aggregation further may be further for: determining the apparatus has invalid or incomplete measurements with respect to a second link of the dual connectivity; and validating over a validation time period the invalid or incomplete measurements.

The means for implementing a measurement behaviour starting from the determining, the measurement behaviour configured to reduce any setup or resume delay with respect to the implementing dual connectivity and/or carrier aggregation may further be for: determining the apparatus has invalid or incomplete measurements with respect to a second link of the dual connectivity; and measuring over the second link based on an index reading time period.

The index reading time period may be an index reading period without gaps integer multiplied by a synchronization Signal Block based measurement timing configuration period or Signal Block based for a measured cell.

The index reading period without gaps integer may be a first value when the measured cell is reported and a second values otherwise.

The first value may be 0.

The second value may be one of: 6; 5; 4; 3; 2; and 1.

The means for implementing a measurement behaviour starting from the determining, the measurement behaviour configured to reduce any setup or resume delay with respect to the implementing dual connectivity and/or carrier aggregation may further be for: determining the apparatus has measurements with respect to a second link of the dual connectivity; and further measuring over the second link based on an index reading time period validating over a validation time period a further set of measurements.

The index reading time period may be an index reading period without gaps integer multiplied by a synchronization Signal Block based measurement timing configuration period for a measured cell, the index reading period without gaps integer being a first value.

The first value may be 12. According to a third aspect there is provided an apparatus for a communication network, the apparatus comprising at least one processor and at least one memory storing instructions that, when executed by the at least one processor, cause the apparatus at least to perform: implementing dual connectivity and/or carrier aggregation within a communications network, implementing dual connectivity and/or carrier aggregation within a communications network being able to perform simultaneous measurements for serving and another carrier, the another carrier being a dual connectivity and/or carrier aggregation target carrier; determining, following an idle and/or an inactive mode of operation, initiating a connection; and implementing a measurement behaviour starting from the determining, the measurement behaviour configured to reduce setup delay with respect to the implementing dual connectivity and/or carrier aggregation.

The apparatus caused to perform implementing a measurement behaviour starting from the determining, the measurement behaviour configured to reduce any setup delay with respect to the implementing dual connectivity and/or carrier aggregation may further be caused to perform: determining the apparatus has no detected cell with respect to a second link of the dual connectivity and/or carrier aggregation; measuring the second carrier based on at least a determined time period for primary synchronization signal or secondary synchronization signal detection.

The apparatus caused to perform implementing dual connectivity and/or carrier aggregation within a communications network being able to perform simultaneous measurements for at least one frequency range may be caused to perform implementing dual connectivity and/or carrier aggregation within a communications network being able to perform simultaneous measurements for at least two frequency ranges, and the second link of the dual connectivity and/or carrier aggregation employs a second frequency range.

The determined time period may be a synchronization without gaps integer multiplied by a synchronization signal block based measurement timing configuration or synchronization signal block period for a measured cell.

The synchronization without gaps integer may be 24.

The apparatus caused to perform implementing a measurement behaviour starting from the determining, the measurement behaviour configured to reduce any setup or resume delay with respect to the implementing dual connectivity and/or carrier aggregation may further be caused to perform: determining the apparatus has one or more detected cell with respect to a second link of the dual connectivity and/or carrier aggregation; measuring over the second link based on a measurement time period.

The apparatus caused to perform implementing a measurement behaviour starting from the determining, the measurement behaviour configured to reduce any setup or resume delay with respect to the implementing dual connectivity and/or carrier aggregation may further be caused to perform: determining the apparatus has valid measurements with respect to a second link of the dual connectivity and/or carrier aggregation; and reporting the valid measurements with no measurement time period delay.

The apparatus caused to perform implementing a measurement behaviour starting from the determining, the measurement behaviour configured to reduce any setup or resume delay with respect to the implementing dual connectivity and/or carrier aggregation may further be caused to perform: determining the apparatus has valid measurements with respect to a second link of the dual connectivity; and measuring over the second link based on a measurement time period.

The determined measurement time period may be a measurement without gaps integer multiplied by a synchronization Signal Block based measurement timing configuration or synchronization signal block period for a measured cell.

The measurement without gaps integer may be a first value when the measured cell is reported and a second value otherwise.

The first value may be: 0 when a cell index is not acquired and there is a first T_{SSB_time_index_emr_inter} value of 10 samples; 3 when a cell index is not acquired and there is a second T_{SSB_time_index_emr_inter} value of 40 samples; and 0 when a cell index is acquired.

The second value may be 24.

The apparatus caused to perform implementing a measurement behaviour starting from the determining, the measurement behaviour configured to reduce any setup or resume delay with respect to the implementing dual connectivity and/or carrier aggregation further may be caused to perform: determining the apparatus has invalid or incomplete measurements with respect to a second link of the dual connectivity; and validating over a validation time period the invalid or incomplete measurements.

The apparatus caused to perform implementing a measurement behaviour starting from the determining, the measurement behaviour configured to reduce any setup or resume delay with respect to the implementing dual connectivity and/or carrier aggregation may further be caused to perform: determining the apparatus has invalid or incomplete measurements with respect to a second link of the dual connectivity; and measuring over the second link based on an index reading time period.

The index reading time period may be an index reading period without gaps integer multiplied by a synchronization Signal Block based measurement timing configuration period or Signal Block based for a measured cell.

The index reading period without gaps integer may be a first value when the measured cell is reported and a second values otherwise.

The first value may be 0.

The second value may be one of: 6; 5; 4; 3; 2; and 1.

The apparatus caused to perform implementing a measurement behaviour starting from the determining, the measurement behaviour configured to reduce any setup or resume delay with respect to the implementing dual connectivity and/or carrier aggregation may further be caused to perform: determining the apparatus has measurements with respect to a second link of the dual connectivity; and further measuring over the second link based on an index reading time period validating over a validation time period a further set of measurements.

The index reading time period may be an index reading period without gaps integer multiplied by a synchronization Signal Block based measurement timing configuration period for a measured cell, the index reading period without gaps integer being a first value.

The first value may be 12.

According to a fourth aspect, there is provided an apparatus for a communication network, the apparatus comprising: means for implementing dual connectivity and/or carrier aggregation within a communications network, implementing dual connectivity and/or carrier aggregation within a communications network being able to perform simultaneous measurements for serving and another carrier, the another carrier being a dual connectivity and/or carrier aggregation target carrier; means for determining, following an idle and/or an inactive mode of operation, initiating a connection; and means for implementing a measurement behaviour starting from the determining, the measurement behaviour configured to reduce setup delay with respect to the implementing dual connectivity and/or carrier aggregation.

According to a fifth aspect, there is provided an apparatus for a communication network, the apparatus comprising: implementing circuitry implementing dual connectivity and/or carrier aggregation within a communications network, implementing dual connectivity and/or carrier aggregation within a communications network being able to perform simultaneous measurements for serving and another carrier, the another carrier being a dual connectivity and/or carrier aggregation target carrier; determining circuitry configured to determine, following an idle and/or an inactive mode of operation, initiating a connection; and implementing circuitry configured to implement a measurement behaviour starting from the determining, the measurement behaviour configured to reduce setup delay with respect to the implementing dual connectivity and/or carrier aggregation.

According to a sixth aspect, there is provided a computer program comprising instructions [or a computer readable medium comprising instructions] for causing an apparatus for a communication network, to perform at least the following: implementing dual connectivity and/or carrier aggregation within a communications network, implementing dual connectivity and/or carrier aggregation within a communications network being able to perform simultaneous measurements for serving and another carrier, the another carrier being a dual connectivity and/or carrier aggregation target carrier; determining, following an idle and/or an inactive mode of operation, initiating a connection; and implementing a measurement behaviour starting from the determining, the measurement behaviour configured to reduce setup delay with respect to the implementing dual connectivity and/or carrier aggregation.

According to a seventh aspect, there is provided a non-transitory computer readable medium comprising program instructions for causing an apparatus for a communication network to perform at least the following: implementing dual connectivity and/or carrier aggregation within a communications network, implementing dual connectivity and/or carrier aggregation within a communications network being able to perform simultaneous measurements for serving and another carrier, the another carrier being a dual connectivity and/or carrier aggregation target carrier; determining, following an idle and/or an inactive mode of operation, initiating a connection; and implementing a measurement behaviour starting from the determining, the measurement behaviour configured to reduce setup delay with respect to the implementing dual connectivity and/or carrier aggregation.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

According to an aspect, there is provided a non-transitory computer readable medium comprising program instructions for causing an apparatus to perform at least the method according to any of the preceding aspects.

In the above, many different embodiments have been described. It should be appreciated that further embodiments may be provided by the combination of any two or more of the embodiments described above.

### BRIEF DESCRIPTION OF FIGURES

Some examples, will now be described, merely by way of illustration only, with reference to the accompanying drawings in which:

FIG. 1 shows a schematic representation of a 5G system;

FIG. 2 shows a schematic representation of a network apparatus;

FIG. 3 shows a schematic representation of a user equipment;

FIG. 4 illustrates an example of UE transitioning from connected to idle/inactive mode and back to connected mode within which some embodiments can be implemented;

FIG. 5 illustrates a UE mode of operation showing the period where the requirements are not defined for the transition from idle/inactive to connected mode;

FIG. 6 illustrates an example capability signalling indicating a new measurement reporting/state switch capability according to some embodiments;

FIGS. 7 to 11 illustrates example UE behaviours according to some embodiments; and

FIG. 12 illustrates examples which show the reduction of the setup times which can be achieved by implementing the embodiments described herein.

### DETAILED DESCRIPTION

The following describes operations for UE behaviour to reduce setup times and specifically examples for improving secondary cell (SCell)/secondary cell group (SCG) setup delay.

In the following description of examples, certain aspects are explained with reference to devices that are often capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems (for example, current 6G proposals, IEEE 802.11, etc.).

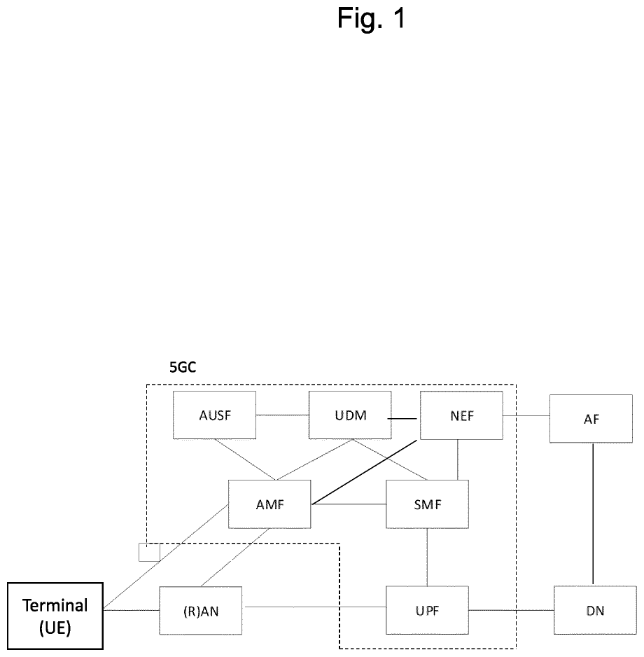

Before describing in detail the examples, certain general principles of a 5G wireless communication system are briefly explained with reference to FIGS. 1 to 3. In the following certain embodiments are explained with reference to apparatuses capable of communication with a communication system serving such apparatuses.

Before explaining in detail the exemplifying embodiments, certain general principles of a communication system, for example a 5G communication system, that can include one or more access network (AN) and a core network, and apparatuses (e.g., terminals served by the communication system are briefly explained with reference to FIGS. 1, 2 and 3 to assist in understanding the technology underlying the described examples.

FIG. 1 shows a schematic representation of a communication network according to an example embodiment of the present disclosure. The communication network comprises a 5G wireless communication system (5GS) and components of an evolved packet system (EPS). The 5GS may be comprised of access networks (ANs) and a 5G core network (5GC). An AN of the 5GS may comprise a 3GPP access network, such as a 5G radio access network (5G-RAN) also called next generation radio access network (NG-RAN).

In some embodiments, an AF, which is a customer of the 5GC, is connected to a user plane function (UPF) of the 5GC via a DN and to various network functions (NFs) of the 5GC via a network exposure function (NEF) of the 5GC. In some embodiments, the AF is a trusted application function and hence the trusted AF is implemented in the 5GC and connected to directly to other NFs of the 5GC. It will be appreciated that although only one UPF is shown in FIG. 1, the 5GS may be composed of a chain of UFPs that include a UPF anchor that connects to the DN. The AF may, transmit to and receive from the various NFs of the 5GC, control plane signalling directly or via the NEF. The AF may also transmit user plane traffic to and receive user plane traffic from the anchor UPF of the 5GC via the DN. The connections between elements drawn in FIG. 1, are via interfaces defined in TS 23.501 and 23.502 of the 3GPP standard.

The 5GC may comprise for instance the following network functions (NFs) (otherwise referred to as network entities): Network Slice Selection Function (NSSF); Network Exposure Function (NEF); Network Repository Function (NRF); Network Data Analytics Function (NWDAF), Policy Control Function (PCF); Unified Data Management (UDM); Authentication Server Function (AUSF); an Access and Mobility Management Function (AMF); a Session Management Function (SMF) and User Plane Function (UPF). The NFs of the 5GC may have a service-based architecture as described in TS 23.501 of the 3GPP standard. NF services that may be offered by the NFs of the 5GC and service-based interfaces for the NFs of the 5GC are described in 3GPP standard, and in particular in TS 23.501 and 23.502 of the 3GPP standard.

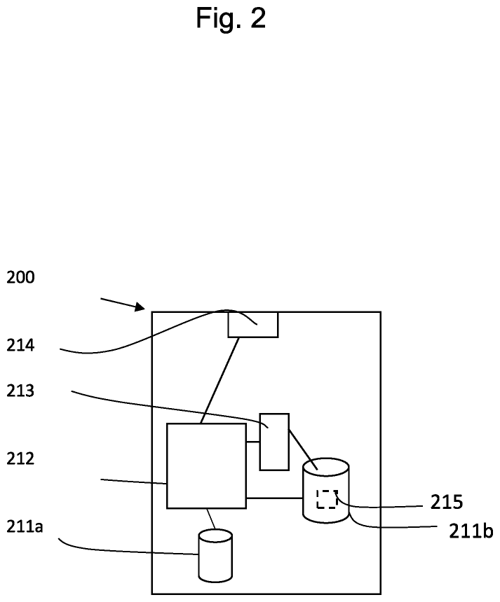

FIG. 2 illustrates an example of an apparatus 200 that may implement one or more NFs of the 5GC illustrated in FIG. 1. The apparatus 200 may comprise at least one random access memory (RAM) 211a, at least one read only memory (ROM) 211b, at least one processor 212, 213 and a network interface 214. The at least one processor 212, 213 may be coupled to the RAM 211a and the ROM 211b. The at least one processor 212, 213 may be configured to execute software code 215. The software code 215 may for example include instructions to perform actions or operations of one or more NFs of the 5GC. The software code 215 may be stored in the ROM 211b. The apparatus 200 may implement one or more NFs of the 5GC and may be interconnected with another apparatus 200 implementing one or more other NFs of the 5GC. In such embodiments, the apparatuses 200 may be part of a distributed computing system. In some embodiments, each NF of the 5GC may be implemented on a single apparatus 200. In such embodiments, the apparatus 200 may be a cloud computing system.

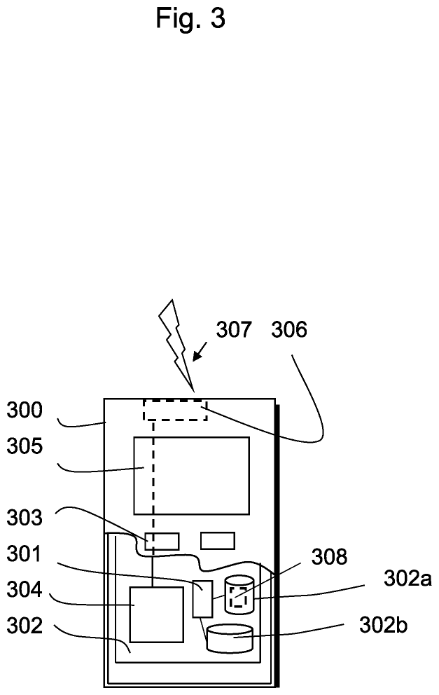

A possible wireless communication device will now be described in more detail with reference to FIG. 3 showing a schematic, partially sectioned view of a communications apparatus 300. FIG. 3 illustrates an example of a communications apparatus 300 illustrated on FIG. 1. The apparatus may be any wireless communication device capable of sending and receiving radio signals. Such apparatus can also be a terminal device, wireless communication device, user equipment (UE), a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (loT) communication device or any combinations of these or the like. In the following discussion the examples are generally concerned with a user equipment but it would be understood that the same principles can be applied to any of the examples of apparatus discussed above.

The apparatus 300 may be configured to communicate with base stations (e.g., a NG-eNB or a gNB) of an access network, such as the 5G-RAN.

The communications may include or carry one or more of voice, electronic mail (email), text message, multimedia, data, machine data and so on.

The apparatus may receive wireless signals (e.g., radio or cellular signals) over an air or radio interface 307 (generally referred to as a Uu interface) via appropriate apparatus 306 for receiving the wireless signals and may transmit wireless signals e.g., radio or cellular signals) via appropriate apparatus for transmitting the wireless signals. In FIG. 3 the apparatus includes one or more antennas (or an antenna array comprising a plurality of antennas) and a transceiver and is designated schematically by block 306. The apparatus 300 may be provided for example by means of a radio part and associated antenna arrangement comprising one or more antennas. The antenna arrangement may be arranged internally or externally to the mobile device.

The apparatus 300 may include at least one processor 301, at least one memory ROM 302a, at least one RAM 302b and other possible components 303 for use in software and hardware aided execution of tasks it is designed to perform, including control of access to and communications with access networks, such as the 5G-RAN access network, and other apparatuses 300. The at least one processor 301 is coupled to the RAM 311a and the ROM 311b. The at least one processor 301 may be configured to execute an appropriate software code 308. The software code 308 may for example include instructions which when executed by the at least one processor 301 perform one or more actions or operations of present aspects. For example the software code can comprise instructions suitable for implementing one or more actions or operations in accordance with aspects of the present disclosure. The software code 308 may be stored in the ROM 311b.

The at least one processor 301, storage and other relevant control apparatus can be provided on an appropriate circuit board or chipsets, or circuit board and chipsets. This feature is denoted by reference 304. The terminal 300 may optionally have a user interface such as key pad 305, touch sensitive display screen or touch sensitive pad, combinations thereof or the like. Optionally one or more of a display, a speaker and a microphone may be provided depending on the type of the device.

The following description also provides illustrative examples with reference to Primary Secondary Cells (PSCells), Primary Cells (PCells), and Secondary Cells (SCells). The following will outline features of PSCells in relation to 5G New Radio, using terminology used therein. However, it is understood that the presently described principles are not limited to such terminology, and may be applied to other systems having a similar architecture. For example, in multi-radio-dual connectivity (MR-DC), a Primary Cell (PCell) may be a Long Term Evolution (LTE) cell (e.g., Evolved-Universal Terrestrial Radio Access-New Radio-dual connectivity (EN-DC)).

PSCells are a type of cell currently defined in 5G New Radio, along with Primary Cells (PCells), Secondary Cells (SCells) and Special Cells (SpCells). A PCell may be used as part of an initial access between a UE and an access network, and is considered to be a main cell in a master cell group (MCG). A PSCell may be comprised as part of a secondary cell group (SCG). The SpCells and SCells may be in at least one of the MCG and the SCG.

The cells may be controlled by network nodes. There are a maximum of two different types of network nodes in 5G New Radio: Master nodes (which provide a control plane connection to a core network); and Secondary Nodes (which do not have control plane connections to the core network). It is understood that not all 5G system deployments may comprise a master node and secondary node. For example, the Master and Secondary nodes may be present in a master node-dual connectivity deployment, but not in a standalone deployment. The Master and Secondary nodes may both provide user plane (e.g. data) connections to the core network. The Master node may control the PCell. In addition to the PCell, the Master node may control at least one PSCell, although this is not always the case. The Secondary node may control at least one PSCell.

3GPP has issued a number of releases (Rel) for defining operating communication protocols related to a communications network. Currently, objectives and work are being set in relation to Release 18 (Rel. 18).

When a UE moves from the coverage area of one cell to another cell, at some point a serving cell change needs to be performed. Currently serving cell change is triggered by L3 (Layer 3—the network layer) measurements and is implemented by RRC (Radio Resource Control) signalling triggered Reconfiguration with Synchronisation for change of PCell (Primary Cell) and PSCell (Primary Secondary Cell), as well as release SCells (Secondary Cells) when applicable.

All cases involve complete L2, or Layer 2: the MAC (Medium Access Control) RLC (Radio Link Control) and PDCP (Packet Data Convergence Protocol) layer (and L1 or Layer 1, the physical layer) resets, leading to longer latency, larger overhead and longer interruption time than beam switch mobility.

An aim of L1/L2 mobility enhancements is to enable a serving cell change via L1/L2 signalling, in order to reduce the latency, overhead and interruption time.

In Rel. 17 Conditional PSCell change (CPC)/Conditional PSCell addition (CPA), a CPC/CPA-configured UE is configured to release the CPC/CPA configurations when completing random access towards the target PSCell. Hence the UE does not have a chance to perform subsequent CPC/CPA without prior CPC/CPA reconfiguration and re-initialization from the network.

This increases the delay for the cell change and increase the signalling overhead, especially in the case of frequent SCG (secondary cell group) changes when operating FR2 (frequency range 2).

There has been research into Multi-Radio access technology-Dual Connectivity (MR-DC) with selective activation of cell groups which aims at enabling subsequent CPC/CPA after SCG change, without reconfiguration and re-initialization on the CPC/CPA preparation from the network. This would result in a reduction of the signalling overhead and further reduce any interrupt time for implementing SCG changes.

Currently, Conditional Hand Over (CHO) and MR-DC cannot be configured simultaneously. This limits the usefulness of these two features when MR-DC is configured.

There is currently being studied the impact of FR2 RRM mobility measurement acquisition and reporting on FR2 SCell/SCG setup/resume delay for a UE connecting from idle/inactive mode.

Additionally there is being researched improvements in FR2 SCell/SCG setup delay based on defining new UE measurement procedures and RRM core requirements. This research is examining whether additional information from the network would help the UE to perform those measurements effectively.

In these investigations the following sequence of events are that the UE initiates and performs improved measurements when RRC connection setup/resume is requested and after acquiring those improved measurements, the UE subsequently reports those measurements to the network to support SCell/SCG setup.

Furthermore there have been investigations into the reuse of the IDLE/INACTIVE mode measurement results which are to be reported during and/or after RRC connection setup/resume in order to improve SCell/SCG setup delay. These investigations include: examining availability and validation of the IDLE/INACTIVE mode measurement results to be reported; and the definition of corresponding RRM requirements; and if necessary based on the outcome, definition of corresponding signalling support.

The impact of FR2 RRM mobility measurement acquisition and reporting on FR2 SCell/SCG setup/resume delay for a UE connecting from idle/inactive mode. The results show that enabling fast DC (Dual Connectivity)/CA (Carrier Aggregation) resume/setup enables data DC/CA usage with lower latency, higher throughput, enhances load balancing and enables lower UE energy consumption and can improve UE, network and system performance significantly.

Research has been working on the issue of enhancing CA and DC setup delays in Rel-15 (enhanced utilization of CA (euCA)) for LTE, enabling early reporting of LTE inter-frequency carriers/cells measured in idle mode when UE is entering connected mode.

The enhanced measurement reporting (EMR) defined in Rel-16 includes setup enhancements when UE is operating in NR (and including intra-NR and NR-LTE inter-RAT measurements). However, the outcome mostly benefitted NR FR1 (Frequency range 1) and LTE-Inter-RAT performance while the setup delays for NR FR2 (Frequency range 2) CA/DC setup could be further enhanced.

Rel-18 is specified to either still continue using the EMR terminology, or to use use eEMR or enhanced EMR or measurement validation or similar terms. In the following where delay components are described they are not limited to EMR UEs, but also UEs not supporting EMR. Hence, such UEs can also support these measurements. This means that when the validation delays start from RRC setup/resume, it doesn't matter if UE is using (any) idle-mode measurements or measurements it has carried over from the connected mode.

In other words in the examples provided hereafter where the delays “xx_emr_xx” are mentioned that this can also apply in general for any UE including UEs not supporting EMR.

This research has aimed to reduce the setup delay of FR2 CA and FR2 SCG. An example scenario within which embodiments can produce large gains in reducing setup delay is the scenario where the UE is camped in idle and/or inactive mode in for example FR1 (for the master cell group—MCG) while the potential targeted SCell/PSCell is in for example FR2 (the secondary cell group-SCG plus CA; In one example the serving cell, PCell, is in FR1, while the potential target for offloading could be a target cell, PSCell, as hotspot in FR2. Another example would having possible CA target cells in FR2, and hence adding SCells as CA in FR2). These are example, and the serving cell (here listed as PCell) can be in FR1 or FR2 while the target cell (PSCell and/or SCell) may be either in FR1 and/or FR2.

This scenario (target cell is in FR2 while serving cell is in FR1) has a higher delay since the UE in idle mode needs first to detect, measure and report the possible PSCell in FR2 or SCell in FR2 prior to configuring the cell. This causes delays in setup because measurements are needed to see which cells/beams are near the UE.

A possible source of the latencies is the UE having to detect the cell and measure a cell and possibly read the SSB Index (Synchronization Signal Block index) before the cell can be reported to the network. Additionally, it is assumed that in NR FR2 beamforming is applied on both UE and network side. Such use of beamforming (and the UE need for sweeping between multiple Tx/Rx panel) extends the cell detection and measurement procedures compared to FR1 where UE is assumed receiving in an omnidirectional manner (and hence, no beam sweeping is on UE side is necessary). Additionally, the UE may need time for further UE beam refinement which further increases the setup delay.

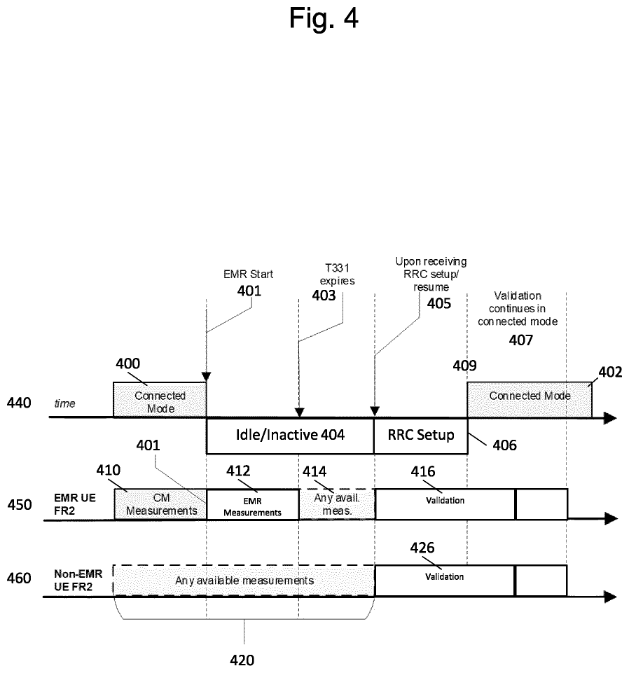

FIG. 4 shows an example scenario such as indicated above with respect to a transitioning from connected mode 400 to another connected mode 402 via an idle/inactive mode 404 and a RRC setup 406. It should be noted that this is one example and scenario may also originate from UE being in Idle or Inactive mode without need for any information from connected mode or being recently in connected mode.

In other words FIG. 4 shows an example where a UE is transitioning from connected mode 400 to idle/inactive mode 404 and back to connected mode 402. The aim of the embodiments as discussed herein should include any measurements that are performed and available at the UE side at or before RRC setup 406 resume occurs, and the measurement validation phase 407 which may start from when UE is initiating or receiving RRC setup/resume 406 and may continue in connected mode 402.

Changes to the existing idle mode and EMR measurements procedures are not within the scope but existing measurements, for example, performed due to UE being configured with EMR or any other available due to UE idle mode measurements, can be used and/or used/validated during the RRC connection setup/resume and during connected mode 402. It would be understood that there is no strict ending point of the measurements or measurement validation.

In the example shown in FIG. 4, there is the upper part 440 demonstrating the UE modes of operations. In this example the UE starts in connected mode 400 and then at a time instant 401, transitions to idle/inactive mode 404. While in idle/inactive mode 404 the UE receives a RRC setup/resume message at point 405 which triggers a RRC setup 406 mode. At some point 409 the UE then transitions to the connected mode 402.

Furthermore is shown in FIG. 4 a non-enhanced measurement reporting UE measuring for example in frequency range 2 (FR2) part 460. This shows that any available measurements performed during period 420 may be performed during the first connected mode 400 and idle/inactive mode 404 and then starting after receiving the RRC setup/resume message a validation operation 426 is implemented, which may use the available measurements from 420, which continues into the second connected mode 402.

Furthermore FIG. 4 shows an enhanced measurement reporting UE operating over frequency range 2 (FR2) part 450. This shows that during the first connected mode 400 then connected mode measurements 410 are made and that at the start of the idle/inactive mode 404 then enhanced measurement reporting measurements, such as described in TS 38.111 4.4.2.1, are performed. After (if) the timer T331 expires 403 UE may stop performing EMR related measurements and will perform normal idle/inactive mode measurements during 414. Then starting, after receiving the RRC setup/resume message, a validation operation 416 is implemented which may continue into the second connected mode 402.

For a UE in idle mode no measurement gaps are needed for performing measurements e.g., on an FR2 inter-frequency carrier. The UE is performing the measurements according to the minimum requirements defined for idle mode. Similar for a UE in inactive mode (for which the UE requirements are the same as in idle mode).

For a UE in connected mode, a UE camped in FR1 and performing for example NR inter-frequency measurements on one or more FR2 carrier(s) e.g. for the purpose of setting up CA/DC, can perform such measurements either using gap assisted measurements or non gap-assisted measurements.

For a UE in connected mode which needs gaps for performing inter-frequency measurements the UE may support either Per-UE measurement gaps or Per-FR UE measurements gaps. If the UE support Per-UE gaps a measurement gap applies for both FR1 and FR2 simultaneously. A UE supporting Per-FR gaps support separate gap patterns per FR (FR1 and FR2) and they may be the same or different gap patterns.

However, for a UE which transitions to connected mode 402 (from idle or inactive 404 mode) there are several aspects regarding how the UE is supposed to perform measurements during the validation phase. It is, for example, not defined how a UE (which may need gaps) would be able to perform measurements prior to receiving a gap configuration. Additionally, it is not clear how a UE is assumed to perform such measurements in case the UE does not need measurements gaps. Or how the UE behaviour and requirements are defined.

Measurement performance and requirements and gap assistance are well defined for Idle mode, inactive mode and connected mode, while the measurement requirements in or during the transitioning phase between idle/inactive mode and connected mode are not defined.

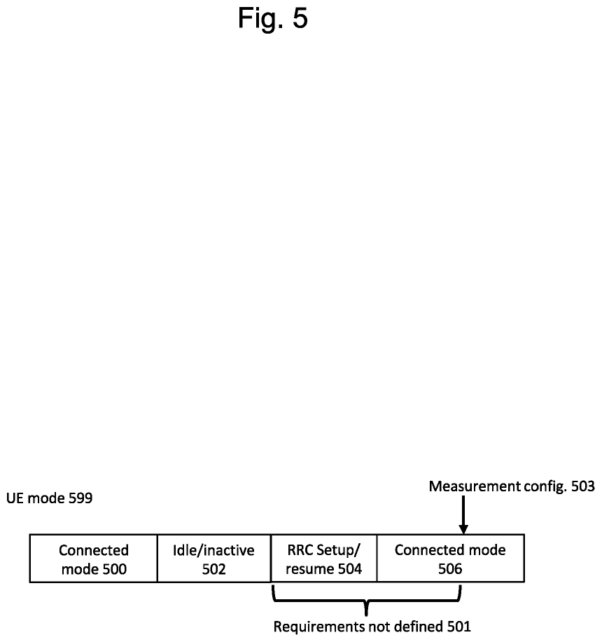

This for example is shown in FIG. 5, where a UE mode 599 is followed. The initial connected mode 500 transitions to an idle/inactive mode 502. In turn a RRC setup/resume 504 is implemented which then transitions into a connect mode 506. As shown in FIG. 5 the requirements are not defined for the RRC setup/resume 504 time or for the connected mode 506 up to the measurement configuration point 503.

The following embodiments thus aim to provide a clear definition of the UE behaviour when the UE is configured to perform measurements for reduced CA/DC setup delay. In the following embodiments and examples the UE behaviour is defined in such a way to aim to produce an efficient and low latency UE operation. The aims of these embodiments can be such that the FR2 CA/DC setup can be improved over baseline inter-frequency based measurements behaviour.

Thus the following describe defining and optimising UE behaviour, measurement requirements and delay during the transition phase from idle/inactive mode to the connected and possibly some time during the initial phase of the connected mode with the purpose of enabling better, faster, and more robust CA/DC setup for 5G/NR FR2 target cell (SCell or PSCell).

As mentioned earlier there is no UE behaviour description or defined UE requirements related to measurements performed by the UE during setup/resume or validation phases. Legacy UE requirements are defined for idle mode, inactive mode and connected mode. However, these requirements are defined separately.

Furthermore with respect to inter-frequency cell detection time for a UE in connected mode, the following applies (from TS 38.133, https://www.3gpp.org/ftp/Specs/archive/38_series/38.133/38133-i00.zip):

UE shall be able to identify a new detectable inter frequency cell within T_{identify_inter_with_index}. The UE shall be able to identify a new detectable inter frequency SS block of an already detected cell within T_{identify_inter_without_index}.

$${T}_{identify \_ inter \_ without \_ index} = ( {T}_{PSS / SSS \_ sync \_ inter} + {T}_{SSB \_ measurement \_ period \_ inter} ) ms$$

$${T}_{identify \_ inter \_ with \_ index} = ( {T}_{PSS / SSS \_ sync \_ inter} + {T}_{SSB \_ measurement \_ period \_ inter} + {T}_{SSB \_ time \_ index \_ inter} ) ms$$

where
M_{pss/sss_sync_inter}:
For a UE supporting FR2 power class 1 or 5, M_{pss/sss_sync_inter}=64 samples.
For a UE supporting FR2 power class 2, M_{pss/sss_sync_inter}=40 samples.
For a UE supporting FR2 power class 3, M_{pss/sss_sync_inter}=40 samples.
For a UE supporting FR2 power class 4, M_{pss/sss_sync_inter}=40 samples.
M_{SSB_index_inter}:
For a UE supporting FR2 power class 1 or 5, M_{SSB_index_inter}=40 samples.
For a UE supporting FR2 power class 2, M_{SSB_index_inter}=24 samples.
For a UE supporting FR2 power class 3, M_{SSB_index_inter}=24 samples.
For a UE supporting FR2 power class 4, M_{SSB_index_inter}=24 samples.
M_{meas_period_inter}:
For a UE supporting FR2 power class 1 or 5, M_{meas_period_inter}=64 samples.
For a UE supporting FR2 power class 2, M_{meas_period_inter}=40 samples.
For a UE supporting FR2 power class 3, M_{meas_period_inter}=40 samples.
For a UE supporting FR2 power class 4, M_{meas_period_inter}=40 samples.
where:

$${T}_{PSS / SSS \_ sync \_ inter} = Max ( 600 ms , Ceil ( Kgap \times {M}_{pss / sss \_ sync \_ inter} ) \times Max ( MGRP , SMTCperiod ) ) \times {CSSF}_{inter}$$

$${T}_{SSB \_ time \_ index \_ inter} = Max ( 200 ms , Ceil ( Kgap \times {M}_{pss / sss \_ index \_ inter} ) \times Max ( MGRP , SMTCperiod ) ) \times {CSSF}_{inter}$$

$${T}_{SSB \_ measurement \_ period \_ inter} = Max ( 400 ms , Ceil ( Kgap \times {M}_{meas \_ period \_ inter} ) \times Max ( MGRP , SMTCperiod ) ) \times {CSSF}_{inter}$$

For a UE which needs gaps for performing inter-frequency measurement: Assuming gaps assigned and only one carrier measured, a number of the scaling factors in the delays can be ignored. For FR2 SCell and PSCell usage the network would need to know the Index in order to be able to know where to reach the UE in DL. Hence, in this case:
T_{identify_inter_with_index}=(40+24+40)*SMTC periods in worst scenario
   when only 1 carrier is measured and assuming MGRP=40 ms. Hence, in all 104*40=4160 ms

For a UE which support inter-frequency measurement without gaps for this particular carrier, the specification captures following:

For per-FR measurement gap capable UE in NR standalone operation (with single carrier, NR CA and NR-DC configuration), for per-FR gap based measurement, when there is no serving cell in a particular FR, where measurement objects are configured, regardless if explicit per-FR measurement gap is configured in this FR, the effective MGRP in this FR is used to determine requirements [for example as described in TS38.133, Section 9.1.2];
20 ms for FR2 NR measurements
40 ms for FR1 NR measurements
40 ms for LTE measurements
40 ms for FR1+LTE measurements

Hence, for FR2, this requirement covers the no gap assisted measurements if there is no serving cell in the FR.

In this case:
T_{identify_inter_with_index}=(40+24+40)*20 ms in worst scenario when only 1 carrier is measured. Hence, in all 104*20=2080 ms.

Additionally, there has been defined a gap assisted and non-gap assisted inter-frequency measurements in TS 38.133.

However, for connected mode, the UE is (only) required to perform measurements in connected based on an explicit network configuration (measurement configuration). Hence, the UE is not required to perform measurements in connected mode on other carriers than the serving carrier, before the UE has received the explicit configuration.

In the following examples the method and apparatus are configured to employ an FR2 target carrier/cell. However, the method and apparatus is not limited to FR2. For example, the methods and following examples may be applicable to carrier/cells in FR1 and/or FR2-2.

In the following examples the UE is assumed to be capable of performing measurements independently in FR1 and FR2 (in other words the UE supports carrier aggregation and/or dual connectivity as one of the UE supported band combination with the measured carrier/cell). In these examples the UE is equipped with at least two independent RF chains and baseband processing modules or UE can receive both carriers simultaneously. In other words the measurements can be performed simultaneously or substantially simultaneously.

In the following examples the UE is assumed to support Rel-16 early measurement reporting feature, EMR. For example a UE that supports rel-16 EMR flagsidleModeMeasurementsNR, idleModeMeasurementsEUTRA.

However the embodiments can be extended to other UEs, such as those UEs that support some of the proposed EMR features independently from the rel-16 EMR framework. Where explicitly referred to then these requirements apply to the “non-EMR UEs”. In other words for UEs that support rel-18 or later features but do not support rel-15 or rel-16 EMR framework.

In the following examples there is shown a validation phase, which can be quick and beneficial for both UE and the network, where the UE may conduct none, one or more measurements.

The type of measurements, the number of samples, the carriers to measure, carrier priorities, number of active receive chains, and details of the measurements are aspects which are not defined in detail herein. In general, the validation phase delay can be as short as possible as FR2 measurement results can easily become obsolete if a time interval between measurement and reporting is too long.

The concept as expressed in further detail in the embodiments herein is defining a new UE measurement behaviour starting from RRC setup-resume (switching from idle→active UE state and where the UE starts for example based on receiving a paging message or initiating a random access procedure to the serving cell) and continuing for some time during connected mode. The UE behaviour aims to make a significant difference to FR2 CA/DC setup/resume delay, for example with respect to SCell setup.

In some cases, this does not require the UE needs to perform measurements during RRC setup/resume. In some cases the UE can start to try to perform measurements during RRC setup/resume but may also start the measurements from connected mode. In both cases the measurements do not need to stop once RRC setup/resume complete is transmitted.

It is worth highlighting that during idle mode, UE requirements consider DRX. From RRC setup/resume, UE will not or is not assumed to use DRX in the serving cell in which connection is established at least until UE receives a DRX configuration in connected mode.

Thus as an aim to improve the delays, the following embodiments define new UE behaviour and related measurement requirements for reduced FR2 SCell/SCG setup. The improvements to the behaviour starts when UE is aware of RRC setup/resume. The examples show a use case scenario where the UE is camped in FR1 (e.g., in idle mode) when connection setup is initiated. The embodiments however can be employed to other scenarios, for example FR2-FR2 inter-band scenarios.

As the UE is assumed to potentially have separate RF chains and at least being able to separately measure FR1 and FR2 bands, the UE needs no measurement gaps for performing the targeted NR FR2 inter-frequency measurements. Thus when PCell in idle and the UE is about to switch into active then the UE is configured to perform measurements configured based on PCell, which may include measurements on FR2 frequency on separate RF chain. Furthermore when the second RF chain is inactive (or the whole UE is idle/inactive) then it can be used for measurements on other frequencies (or the same frequency) to speed up measurements.

This is clear in the scenario where the UE is assumed to only measure target carrier/cells which the UE can use in CA and/or DC combinations with serving carrier/cell (where access is initiated). Therefore, the embodiments focus on defining requirements for non-gap assisted measurement scenario(s).

The following embodiments defines UE measurement requirements for validation or validation delay requirements when:
The UE can measure the target carrier without gaps;
The UE can measure the target carrier as intra-frequency carrier;
Some measurements may be available at the UE when the UE becomes aware of RRC setup/resume.

As such the embodiments the UE is configured to report an inter frequency cell within a defined time T_{identity_emr_inter}. This is based on intra-frequency requirements and the UE is further configured to report the cell accounting the current status of the target cell measurements:
identify a new detectable inter frequency cell; and/or
identify a SS block of an already detected cell; and/or
perform measurements

Within the defined time T_{identity_emr_inter} the UE is thus configured to measure a target cell. In all:

$${T}_{identify \_ emr \_ inter} = ( {T}_{PSS / SSS \_ sync \_ inter} + {T}_{SSB \_ measurement \_ period \_ inter} + {T}_{SSB \_ time \_ index \_ inter} ) ms$$

where:
T_{PSS/sss_sync_emr_inter}=0 if target cell is detected and potentially reported to the network (e.g. as part of EMR), otherwise it can be, but not limited to, 24 in the table below the value is defined as G1.
T_{SSB_measurement_period_emr_inter}=Y1 if cell has been measured and potentially reported to the network (e.g. as part of EMR), otherwise Y2, where Y1 can be, but not limited to, 24 and Y2 can be, but not limited to, 0.
T_{SSB_time_index_emr_inter}=0 if cell Index has been acquired and potentially reported to the network with Index (e.g. as part of early measurement reporting), otherwise Z1, where Z1 is a value such as for example 40.

As discussed earlier, the references to ‘emr’ such as T_{identify_emr_inter} can refer to or apply to eEMR implementations.

Suitable values can be

| | | | S | S | | | | |
|---|---|---|---|---|---|---|---|---|
| TPSS/ | | TSSB_time_in- | Pss/ | meas | S | | | |
| SSS_sync_eEMR_inter | TSSB_measurement_pe- | dex_eEMR_inter | sss | period | index | Total | | |
| TC is X | riod_eEMR _inter | CI is X | G1 | Y1/Y2 | Z1 | S | SMTC | ms |
| NOT detected | TC NOT detected | NOT acquired | 40 | 24 | 40 | 104 | 20 | 2080 |
| NOT detected | TC NOT detected | acquired | 40 | 24 | 0 | 64 | 20 | 1280 |
| NOT detected | TC detected | NOT acquired | 40 | 0 | 40 | 80 | 20 | 1600 |
| NOT detected | TC detected | acquired | 40 | 0 | 0 | 40 | 20 | 800 |
| detected | TC NOT detected | NOT acquired | 0 | 24 | 40 | 64 | 20 | 1280 |
| detected | TC NOT detected | acquired | 0 | 24 | 0 | 24 | 20 | 480 |
| detected | TC detected | acquired | 0 | 0 | 40 | 40 | 20 | 800 |
| detected | TC detected | acquired | 0 | 0 | 0 | 0 | 20 | 0 |
| detected | TM validation needed | acquired | 0 | 12 | 0 | 12 | 20 | 240 |
| detected | TM validation needed | acquired | 0 | 8 | 0 | 8 | 20 | 160 |
| detected | TM validation needed | acquired | 0 | 6 | 0 | 6 | 20 | 120 |
| detected | TM validation needed | acquired | 0 | 5 | 0 | 5 | 20 | 100 |
| detected | TM validation needed | acquired | 0 | 4 | 0 | 4 | 20 | 80 |
| detected | TM validation needed | acquired | 0 | 3 | 0 | 3 | 20 | 60 |
| detected | TM validation needed | acquired | 0 | 2 | 0 | 2 | 20 | 40 |
| detected | TM validation needed | acquired | 0 | 1 | 0 | 1 | 20 | 20 |

In the above table TO is the abbreviation for target cell, Cl is the abbreviation for cell index, TM is the abbreviation for Target measurement, S is the abbreviation for samples.

In some embodiments the T_{PSS/SSS_sync_emr_inter} is undefined for the example when UE has no knowledge about the target carrier/cell (no cell information) and potentially nothing has been reported to the network as part of the procedure.

In such embodiments there is provided a flexible method for defining the UE requirements based on the currently available measurements in the UE when this procedure is initiated (for example at setup/resume).

By employing a step-based requirement, then in some embodiments an improved UE behaviour and implementation can be observed.

Additionally, as shown in the above table, in some embodiments the above is combined with reporting in order to allow the network to have better knowledge concerning the expected UE delays rather than relying on worst case scenario requirements (UE minimum requirements).

In some embodiments a new UE capability indicator for this new behaviour is sent from UE to the network/base station.

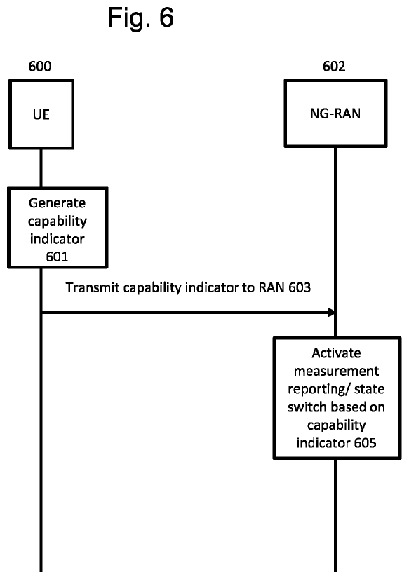

Thus for example as shown in FIG. 6 is shown a UE 600 which having determined that it is capable of supporting the embodiments described herein is configured to generate a suitable capability indicator as shown by 601.

The UE 600 can then transmit the capability indicator to a RAN (or suitable network function) as shown by 603.

The RAN, for example NG-RAN 602 is then configured to receive the indicator and based on the indicator active the measurement reporting/state switch as shown by 605. In other words the if the UE is indicated to support this new feature, the improved measurement reporting/state switch is activated by the network/base station.

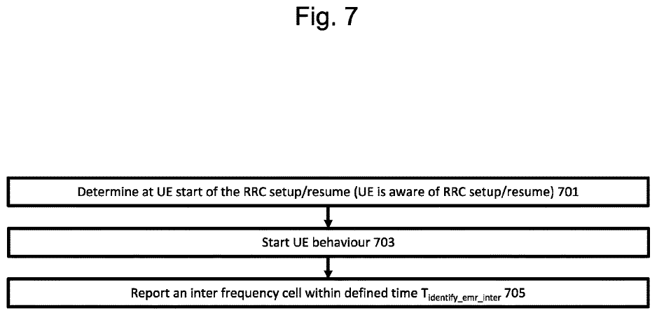

With respect to FIG. 7 a flow diagram showing in summary the operations according to some embodiments.

Thus for example the first operation is one of determining at the UE the start of the RRC setup/resume (UE is aware of RRC setup/resume) as shown by 701.

Then the UE behaviour is started as shown by 703.

Then the report (for example an inter frequency cell report) is generated and passed to the RAN within defined time T_{identify_emr_inter} as shown by 705.

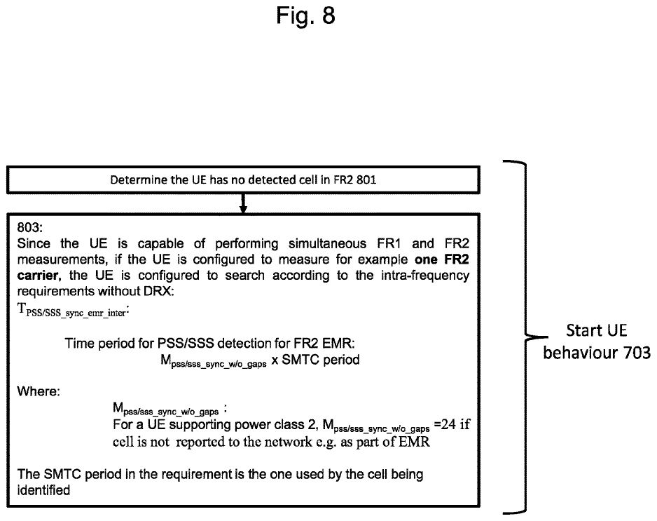

With respect to FIGS. 8 to 11 is shown a series of behaviours defined to be implemented by the UE according to some embodiments.

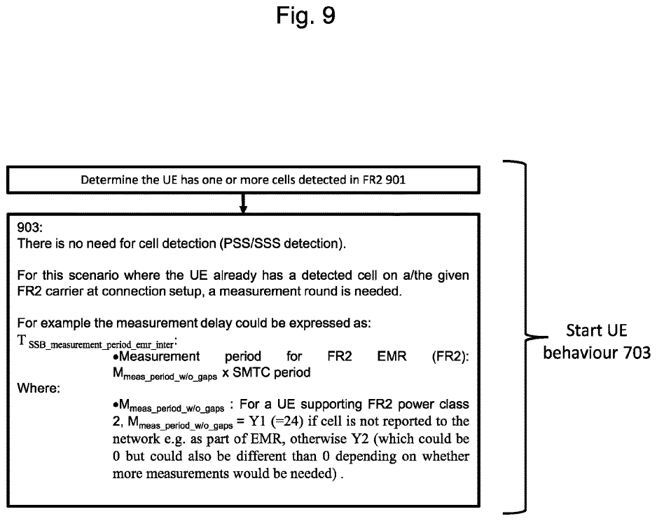

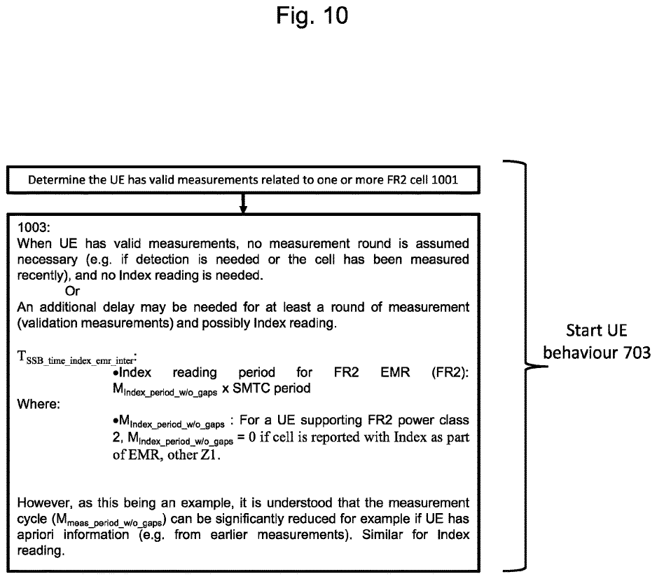

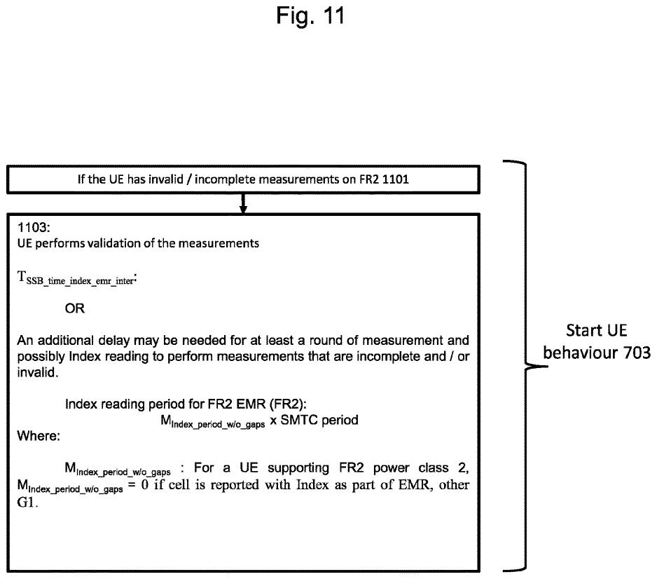

In these examples there are different UE conditions (available measurements at UE side when UE become aware of connection setup/resume) for the following scenarios:
the UE has no detected cell in FR2 (shown with respect to FIG. 8);
the UE has at least one cell detected in FR2 (shown with respect to FIG. 9);
the UE has valid measurements related to an FR2 cell (shown with respect to FIG. 10); and
the UE has invalid/incomplete measurements on FR2 and UE performs validation of the measurements (shown with respect to FIG. 11).

With respect to FIG. 8 is shown the UE behaviour with respect to the scenario when the UE has no detected cell in FR2.

Thus for example the UE is configured to determine that it has no detected cell in FR2 as shown by 801.

Then as shown by 803, since the UE is capable of performing simultaneous FR1 and FR2 measurements, if the UE is configured to measure for example one FR2 carrier, the UE is configured to search according to the intra-frequency requirements without DRX:

### T_{PSS/SSS_sync_emr_inter}:

Time period for PSS/SSS detection for FR2 EMR:

$${M}_{pss / sss \_ sync \_ w / o \_ gaps} \times SMTC period$$

$$Where :$$

$${M}_{pss / sss \_ sync \_ w / o \_ gaps} :$$

For a UE supporting power class 2, M_{pss/sss_sync_w/o_gaps}=24 (or another suitable value, for example, as shown in the table earlier) if cell is not reported to the network e.g. as part of EMR

The SMTC period in the requirement is the one used by the cell being identified which alternatively could also be the SSB repetition period of the cell.

This delay in some embodiments is applicable if the UE has no FR2 detected cell on the FR2 carrier at connection setup.

With respect to FIG. 9 is shown the UE behaviour with respect to the scenario when the UE has at least one cell detected in FR2

Thus for example the UE is configured to determine that the UE has one or more cells detected in FR2 as shown by 901.

Then as shown by 903, as the UE already has one or more cells detected in FR2 (either on a specific carrier or in an FR2 band) there is no need for cell detection (PSS/SSS detection). For this scenario where the UE already has a detected cell on a/the given FR2 carrier at connection setup, only a measurement round would be needed.

As an example, for the scenario example discussed above, the measurement delay could be expressed as:

T _{SSB_measurement_period_emr_inter}:

Measurement period for FR2 EMR (FR2):

$${M}_{meas \_ period \_ w / o \_ gaps} \times SMTC period$$

$$Where : {M}_{meas \_ period \_ w / o \_ gaps} :$$

For a UE supporting FR2 power class 2, M_{meas_period_w/o_gaps}=Y1 (=24 or other suitable value) if cell is not reported to the network e.g. as part of EMR, otherwise Y2 (which could be 0 but could also be different than 0 depending on whether more measurements would be needed).

With respect to FIG. 10 is shown the UE behaviour with respect to the scenario when the UE has valid measurements related to an FR2 cell.

Thus for example the UE is configured to determine that the UE has valid measurements related to an FR2 cell as shown by 1001.

Then as shown by 1003, as the UE has valid measurements, no measurement round is necessary (for example if detection is needed or the cell has been measured recently), and no Index reading is needed.

In some embodiments an additional delay may be needed for at least a round of measurement (validation measurements) and possibly Index reading.

T_{SSB_time_index_emr_inter}:

Index reading period for FR2 EMR (FR2):

$${M}_{index \_ period \_ w / o \_ gaps} \times SMTC period$$

$$Where : {M}_{index \_ period \_ w / o \_ gaps} :$$

For a UE supporting FR2 power class 2, M_{Index_period_w/o_gaps}=0 if cell is reported with Index as part of EMR, otherwise M_{Index_period_w/o_gaps}=Z1 (with a value such as indicated earlier).

As an example, it is understood that the measurement cycle (M_{meas_period_w/o_gaps}) can be significantly reduced. For example where the UE has apriori information (such as from earlier measurements). Similarly for Index reading.

With respect to FIG. 11 is shown the UE behaviour with respect to the scenario when the UE has invalid or incomplete measurements related to an FR2 cell.

Thus for example the UE is configured to determine that the UE has invalid or incomplete measurements related to an FR2 cell as shown by 1101.

Then as shown by 1103, as the UE has invalid/incomplete measurements on FR2 and UE performs validation of the measurements.

T_{SSB_time_index_emr_inter}:

In another alternative embodiment an additional delay may be needed for at least a round of measurement and possibly Index reading to perform measurements that are incomplete and/or invalid.

Index reading period for FR2 EMR (FR2):

$${M}_{index \_ period \_ w / o \_ gaps} \times SMTC period$$

$$Where : {M}_{index \_ period \_ w / o \_ gaps} :$$

For a UE supporting FR2 power class 2, M_{Index_period_w/o_gaps}=0 if cell is reported with Index as part of EMR, otherwise it is G1. G1 is a variable to identify a further unique value. The above variable labels are example labels and in a manner similar to the example variable values can differ from implementation to implementation or from embodiment to embodiment.

In one example, the UE behaviour could be illustrated by the following standard specification addition. This addition is could for example be part of the SCell and/or PSCell addition or activation requirements (and similarly for PSCell addition). Using SCell activation delay as an example then a new standard specification section can be introduced for defining Direct SCell activation delay for an EMR carrier (in FR2):

### 8.3.x Direct SCell Activation for an EMR Target SCell

The requirements in this clause apply for UE being configured in the RRC reconfiguration message, TS 38.331, with at least one SCell which has been provided to the network in EMR reporting and for which the parameter sCel/State is set to activated.

The UE shall configure the SCell in activated state upon successful completion of the RRC reconfiguration procedure within the specified delay. The UE shall be capable to transmit valid CSI report and apply actions for the directly activated SCell no later than in slot

$$n + \frac{{N}_{direct}}{NR slot length} ,$$

### Where:

Slot n is the last slot overlapping with the PDSCH containing RRC reconfiguration message.
N_{direct}=T_{RRC_process}+T_{activation_time}+T_{CSI_Reporting}−3 ms for the cases specified in clause 8.3.2 that TCI state is not indicated within T_{activation_time}; otherwise,

$${N}_{direct} = {T}_{RRC \_ process} + {T}_{HARQ} + {T}_{activation \_ time} + {T}_{CSI \_ Reporting}$$

where:
T_{RRC_Process}: RRC procedure delay as specified in clause 11.2 of TS 36.331 if the corresponding RRC message is embedded in E-UTRA RRC message, otherwise it is the RRC procedure delay defined in clause 12 of TS 38.331,
T_{HARQ} (in ms) is the timing between DL data transmission and acknowledgement as specified in TS 38.213,
T_{activation_time}: is the SCell activation delay in millisecond and defined as:

$${T}_{activation \_ time} = ( {M}_{pss / sss \_ sync \_ w / o \_ gaps \_emr} \times SMTC period ) + ( {M}_{meas \_ period \_ w / o \_ gaps \_emr} \times SMTC period ) + ( {M}_{SSB \_ time \_ index \_ emr \_inter} \times SMTC period ) ,$$

where
M_{PSS/SSS_sync_emr_inter}=0 if cell is reported to the network, otherwise 24.
M_{SSB_measurement_period_emr_inter}=Y1 if cell is reported to the network, otherwise 24
M_{SSB_time_index_emr_inter}=0 if cell is reported to the network with Index, other 24
and T_{CSI_Reporting} is specified in clause 8.3.2, where the following definitions of T_{FirstSSB} and T_{FirstSSB_MAX} shall override the existing ones:
T_{FirstSSB}: the time to the end of the first complete SSB burst indicated by the SMTC after slot

$$n + \frac{{T}_{RCC \_ Process} + {T}_{interrupt}}{NR slot length}$$

T_{FirstSSB_MAX}: the time to the end of the first complete SSB burst indicated by the SMTC after slot

$$n + \frac{{T}_{RCC \_ Process} + {T}_{interrupt}}{NR slot length}$$

In FR2, the occasion when all active serving cells and SCells being activated or released are transmitting SSB bursts in the same slot.

In addition to CSI reporting defined above, UE shall also apply other actions related to the activation command specified in TS 38.321 for an SCell at the first opportunities for the corresponding actions once the SCell is activated.

This is one illustrative example. Furthermore values of X, Y1 and Y2, Z1, G1 could be equal to 24 if current parameters are assumed (but could also differ or be examined further, for example using values as provided by the table as shown above).

Note as an important aspect, the requirements do not distinguish between known and unknown EMR SCell/PSCell but only on whether the configured cell was reported as part of EMR or not prior to the configuration.

Such embodiments as described above would aim as a minimum to provide a significant reduction in the FR2 SCell or SCG setup delay. Assuming relying on connected mode inter-frequency measurements and reporting delay of 4160 ms (the table above shows delays up to 2080 ms) and being able to reduce the delay to below 500 ms (or as close as 0 or 20 ms as measured from the RRC setup complete) the activation time can be reduced with more than 3 seconds.

Additionally, the implementation of the embodiments described herein can also help reducing the UE power consumption in connected. Thus is because one way for the network to get faster measurement from UE is not to allow UE to enter DRX in connected mode (Allowing UE to enter DRX increases neighbour cell detection and measurements in general). Not allowing UE to enter DRX to ensure faster UE measurement results will increase UE power consumption compared to the scenario where the UE could enter DRX.

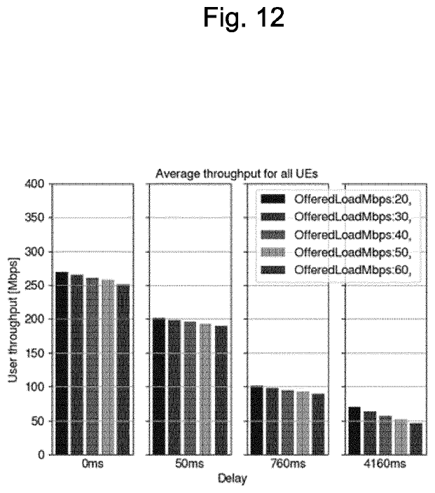

The Example shown in FIG. 12 shows graphs of user throughput in Mbps for a range of delays and offered load. Assuming an activated SCell has been detected in idle mode and EMR information provided to the network, only a measurement round is needed, and thus the worst case delay time is: 480 ms. Even adding additional reporting and SCell configuration delay it is clear from FIG. 12 that the setup delay can be decreased significantly compared to relying on inter-frequency measurement and reporting. Hence, it is clearly possible to push the delay the illustrated 760 ms performance in the following figure:

The foregoing description has provided by way of non-limiting examples a full and informative description of some examples. However, various modifications and adaptations may become apparent to those skilled in the relevant arts in view of the foregoing description, when read in conjunction with the accompanying drawings and the claims. However, all such and similar modifications of the teachings will still fall within the scope of the claims.

In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

As provided herein, various aspects are described in the detailed description of examples and in the claims. In general, some examples may be implemented in hardware or special purpose circuits, software code, logic or any combination thereof. For example, some aspects may be implemented in hardware, while other aspects may be implemented in firmware or software code which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software code, firmware code, special purpose circuits or logic, general purpose hardware or controller or other computing devices, or some combination thereof.

The examples may be implemented by computer software code stored in a memory and executable by at least one data processor of the involved entities or by hardware, or by a combination of software code and hardware.

The memory referred to herein may be of any type suitable to the local technical environment and may be implemented using any suitable data storage technology, such as semiconductor based memory devices, magnetic memory devices and systems, optical memory devices and systems, fixed memory and removable memory.

The (data) processors referred to herein may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Further in this regard it should be noted that any procedures, e.g., as in FIG. 11 and/or FIG. 12, and/or otherwise described previously, may represent operations of a computer program being deployed by at least one processor comprised in an apparatus (where a computer program comprises instructions for causing an apparatus to perform at least one action, the instructions being represented as software code stored on at least one memory), or interconnected logic circuits, blocks and functions, or a combination of operations of a computer program being deployed by at least one processor comprised in an apparatus and logic circuits, blocks and functions. The software code may be stored on memory, such as physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used in this application, the term “circuitry” may refer to one or more or all of the following:
(a) hardware-only circuit implementations (such as implementations in only analogue and/or digital circuitry);
(b) combinations of hardware circuits and software cade, such as:
   (i) a combination of analogue and/or digital hardware circuit(s) with software/firmware code and
   (ii) any portions of hardware processor(s) with software code (including digital signal processor(s)), software code, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software code (e.g., firmware) for operation, but the software code may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware code. The term circuitry also covers, for example integrated device.

Implementations of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “non-transitory,” as used herein, is a limitation of the medium itself (i.e., tangible, not a signal) as opposed to a limitation on data storage persistency (e.g., RAM vs. ROM).

The scope of protection sought for various examples of the disclosure is set out by the independent claims. The examples and features, if any, described in this specification that do not fall under the scope of the independent claims are to be interpreted as examples useful for understanding the disclosure.

The foregoing description has provided by way of non-limiting examples a full and informative description of example implementations of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further implementation comprising a combination of one or more implementations with any of the other implementations previously discussed.

1. A method for an apparatus, the method comprising:
implementing at least one of dual connectivity or carrier aggregation within a communications network, the implementing the at least one of dual connectivity or carrier aggregation within a communications network being able to perform simultaneous measurements for serving and another carrier, the another carrier being at least one of a dual connectivity or carrier aggregation target carrier;
determining, following at least one of an idle or inactive mode of operation, initiating a connection; and
implementing a measurement behaviour starting from the determining, the measurement behaviour configured to reduce setup delay with respect to the implementing the at least on of dual connectivity or carrier aggregation.

2. The method as claimed in claim 1, wherein implementing a measurement behaviour starting from the determining, the measurement behaviour configured to reduce any setup delay with respect to the implementing the at least one of dual connectivity or carrier aggregation further comprises:
determining the apparatus has no detected cell with respect to a second link of the at least one of dual connectivity or carrier aggregation;
measuring the second carrier based on at least a determined time period for primary synchronization signal or secondary synchronization signal detection.

3. The method as claimed in claim 2, wherein implementing the at least one of dual connectivity or carrier aggregation within a communications network being able to perform simultaneous measurements for at least one frequency range comprises implementing the at least one of dual connectivity or carrier aggregation within a communications network being able to perform simultaneous measurements for at least two frequency ranges, and the second link of the at least one of dual connectivity or carrier aggregation employs a second frequency range.

4. The method as claimed in claim 2, wherein the determined time period is a synchronization without gaps integer multiplied by a synchronization signal block based measurement timing configuration or synchronization signal block period for a measured cell.

5. The method as claimed in claim 1, wherein implementing a measurement behaviour starting from the determining, the measurement behaviour configured to reduce any setup or resume delay with respect to the implementing the at least one of dual connectivity or carrier aggregation further comprises:
determining the apparatus has one or more detected cell with respect to a second link of the at least one of dual connectivity or carrier aggregation;
measuring over the second link based on a measurement time period.

6. The method as claimed in claim 1, wherein implementing a measurement behaviour starting from the determining, the measurement behaviour configured to reduce any setup or resume delay with respect to the implementing the at least one of dual connectivity or carrier aggregation further comprises:
determining the apparatus has valid measurements with respect to a second link of the at least one of dual connectivity or carrier aggregation; and
reporting the valid measurements with no measurement time period delay.

7. The method as claimed in claim 1, wherein implementing a measurement behaviour starting from the determining, the measurement behaviour configured to reduce any setup or resume delay with respect to the implementing the at least one of dual connectivity or carrier aggregation further comprises:
determining the apparatus has valid measurements with respect to a second link of the dual connectivity; and
measuring over the second link based on a measurement time period.

8. The method as claimed in claim 5, wherein the determined measurement time period is a measurement without gaps integer multiplied by a synchronization Signal Block based measurement timing configuration or synchronization signal block period for a measured cell.

9. The method as claimed in claim 8, wherein the measurement without gaps integer is a first value when the measured cell is reported and a second value otherwise.

10. The method as claimed in claim 1, wherein implementing a measurement behaviour starting from the determining, the measurement behaviour configured to reduce any setup or resume delay with respect to the implementing the at least one of dual connectivity or carrier aggregation further comprises:
determining the apparatus has invalid or incomplete measurements with respect to a second link of the dual connectivity; and
validating over a validation time period the invalid or incomplete measurements.

11. The method as claimed in claim 1, wherein implementing a measurement behaviour starting from the determining, the measurement behaviour configured to reduce any setup or resume delay with respect to the implementing the at least one of dual connectivity or carrier aggregation further comprises:
determining the apparatus has invalid or incomplete measurements with respect to a second link of the dual connectivity; and
measuring over the second link based on an index reading time period.

12. The method as claimed in claim 11, wherein the index reading time period is an index reading period without gaps integer multiplied by a synchronization Signal Block based measurement timing configuration period or Signal Block based for a measured cell.

13. The method as claimed in claim 12, wherein the index reading period without gaps integer is a first value when the measured cell is reported and a second values otherwise.

14. The method as claimed in claim 1, wherein implementing a measurement behaviour starting from the determining, the measurement behaviour configured to reduce any setup or resume delay with respect to the implementing the at least one of dual connectivity or carrier aggregation further comprises:
determining the apparatus has measurements with respect to a second link of the dual connectivity; and
further measuring over the second link based on an index reading time period validating over a validation time period a further set of measurements.

15. The method as claimed in claim 14, wherein the index reading time period is an index reading period without gaps integer multiplied by a synchronization Signal Block based measurement timing configuration period for a measured cell, the index reading period without gaps integer being a first value.

16. An apparatus comprising:
means for implementing at least one of dual connectivity or carrier aggregation within a communications network, the means for implementing the at least one of dual connectivity or carrier aggregation within a communications network being able to perform simultaneous measurements for serving and another carrier, the another carrier being at least one of a dual connectivity or carrier aggregation target carrier;
means for determining, following at least one of an idle or an inactive mode of operation, initiating a connection; and
means for implementing a measurement behavior starting from the determining, the measurement behavior configured to reduce setup delay with respect to the implementing the at least one of dual connectivity or carrier aggregation.

17. An apparatus comprising at least one processor and at least one memory storing instructions that, when executed by the at least one processor, cause the apparatus at least to:
implementing at least one of dual connectivity or carrier aggregation within a communications network, the apparatus caused to implement the at least one of dual connectivity or carrier aggregation within a communications network being able to perform simultaneous measurements for serving and another carrier, the another carrier being at least one of a dual connectivity or carrier aggregation target carrier;
determine, following at least one of an idle or an inactive mode of operation, initiating a connection; and
implement a measurement behavior starting from the determining, the measurement behavior configured to reduce setup delay with respect to the implementing the at least one of dual connectivity or carrier aggregation.
